(19) United States
(12) Patent Application Publication
(10) Pub. No.: US 2004/0171285 A1
(43) Pub. Date: Sep. 2, 2004

(54) Connector

(76) Inventor: Kenji Okura, Hisai-shi (JP)

Correspondence Address: GREENBLUM & BERNSTEIN, P.L.C., 1950 ROLAND CLARKE PLACE, RESTON, VA, 20191, US

(21) Appl. No.: 10/481,884

(22) PCT Filed: Jan. 28, 2003
(86) PCT No.: PCT/JP03/00810

(30) Foreign Application Priority Data
Jan. 28, 2002 (JP) 2002-018856

(51) Int. Cl. H01R 12/00

(52) U.S. Cl. 439/74

(57) ABSTRACT

A connector used electrically for connecting two circuit boards comprises a plurality of sets of contacts held on a body. Each contact has a terminal portion to be soldered on the circuit board, a held portion to be fitted into the body, and a contacting portion to be elastically contacted with a contacting portion of a contact of the counterpart connector when the connectors are coupled with each other. A part of the contact, which generates elastic pressure by warping when the connectors are coupled, is hammered out in a manner so that a thickness of the part is made thinner than other portions for generating work hardening. Elastic pressure acting between the contacts of the connectors coupled with each other is increased by the work hardening, so that reliability of connection can be maintained owing to the increase of the elastic pressure even when a stacking height of the connectors is made lower.

### TECHNICAL FIELD

The present invention relates to connectors electrically for connecting circuit boards each other.

### BACKGROUND ART

Conventionally, connectors are practically used for connecting a plurality of circuit boards on which electronic components are mounted. In mobile equipment such as a mobile phone, the connectors are required to be downsized and to have a low-profile corresponding to the miniaturization and the low-profile of the mobile equipment. On the other hand, a packaging density of the electronic components mounted on the circuit board becomes higher due to high functionality of the mobile equipment, so that number of arrangement of contacts constituting the contact is tend to be increased and the width and pitch of arrangement of the contact become much narrower. Especially in a flip phone, the circuit boards on which the electronic components are mounted are separately disposed on both sides with respect to a hinge, and flexible substrates are used for connecting the separated circuit boards inside of the hinge. Thus, the application of the connectors will be expanded for connecting the circuit boards each other or connecting the electronic components and the circuit boards.

The connectors for connecting two circuit boards each other are constituted by a header corresponding to a male connector mounted on one circuit board and a socket corresponding to a female connector mounted on the other circuit board. The connectors are electrically connected by coupling the header onto the socket.

FIG. 13 shows a state that a header 12 is coupled with a socket 11 which constitute the conventional connectors. FIG. 11 shows a cross-sectional configuration of the socket 11. FIG. 12 shows a cross-sectional configuration of the header 12.

As can be seen from FIG. 11, the socket 11 comprises a body 13 and a plurality of pairs of contacts 14 held on the body 13. The body 13 is a substantially rectangular parallelepiped and has a rectangular recess 13a. The contacts 14 are held on both side walls of the recess 13a of the body 13. Each contact 14 has a terminal portion 14a at which the contact 14 is soldered on a circuit board, a held portion 14b having a substantially horse shoe shaped section, and a contacting portion 14c which is formed by bending an elongation of the held portion 14b so as to have a substantially horse shoe shape in opposite direction to the terminal portion 14a. The contacting portion 14c can be warped in longitudinal direction in FIG. 11. The contact 14 of the conventional connector is formed by bending a metal plate having a uniform thickness “G”, so that the thickness of whole the contact 14 is substantially even.

As can be seen from FIG. 12, the header 12 comprises a body 15 and a plurality of sets of contacts 16 held on the body 15. The body 15 has a rectangular section having a height and a length substantially equal to the depth and the length of the recess 13a of the body 13 of the socket 11. The contacts 16 are fitted into holding grooves formed on both sides of the body 15. Each contact 16 has a terminal portion 16a at which the contact 16 is soldered on a surface of a circuit board, a held portion 16b bent substantially at right angle with respect to the terminal portion 16a and fitted into the holding grooves so that the contact 16 is held on the side of the body 15, and a contacting portion 16c which is formed by bending an elongation of the held portion 16b so as to form a substantially horse shoe shape with the held portion 16b toward the terminal portion 16a. The contacting portion 16c can be warped in longitudinal direction in FIG. 12. The contact 16 of the conventional connector is formed by bending a metal plate having a uniform thickness “H”, so that the thickness of whole the contact 16 is substantially even.

When the header 12 is fitted into the recess 13a of the body 13 of the socket 11, the contacting portion 16c of the contact 16 of the header 12 elastically contacts with the contacting portion 14c of the contact 14 of the socket 11. Thus, not only the electric connection between the contacts 14 and 16 can be available, but also the gripping force between the socket 11 and the header 12 is generated.

In order to increase the packaging density on the circuit boards and to make the mobile equipment low-profile, it is desired to provide the connectors by which a total height A of the connectors when the header 12 is coupled with the socket 11 (hereinafter, called “stacking height”) can be made lower.

In order to make the stacking height lower, it is necessary to make the lengths of the contacting portions 14c and 16c of the contacts 14 and 16 which serve as plate springs shorter, when the contacts 14 and 16 are made by the same thicknesses and materials as those in the conventional connector. When the length of portions of the contacts 14 and 16 serving as the plate spring becomes shorter, elastic pressure acting between the contacting portion 14c of the contact 14 and the contacting portion 16c of the contact 16 becomes smaller. Thus, the electric connection between the contacts 14 and 16 becomes instable and the gripping force acting between the socket 11 and the header 12 becomes smaller. In other words, reliability of the electric connection and impact proof of the connectors used for connecting the circuit boards become lower.

In order to maintain the reliability of the connection between the socket 11 and the header 12 even when the stacking height is made lower, it is necessary to increase the gripping force between the socket 11 and the header 12. It is considered to increase the elastic pressure acting between the contacting portion 14c of the contact 14 and the contacting portion 16c of the contact 16 for increasing the gripping force between the socket 11 and the header 12. In order to increase the elastic pressure, the contacts 14 and 16 can be made a material harder than the conventional material of the contacts. It, however, is generally known that the harder the hardness of a metal becomes, the easier the crack occurs when a plate of the metal is bent. Since the contacts 14 and 16 are made be bending a stuff of a metal plate, the contacts 14 and 16 cannot be formed by bending a stuff of hard metal plate.

### DISCLOSURE OF THE INVENTION

An object of the present invention is to provide connectors having high reliability of connection even when the stacking height is made lower.

A connector in accordance with an aspect of the present invention is mounted on a first circuit board electrically for connecting the first circuit board to a second circuit board by coupling with a counterpart connector mounted on the second circuit board. The connector comprises contacts made of a metal and a body made of an insulation material for holding the contacts. Each contact has a terminal portion to be connected to the circuit board, a held portion to be fixed on the body, and a contacting portion to be elastically contacted with a contacting portion of a contact of the counterpart connector when the connector is coupled with the counterpart connector. The terminal portion, the held portion and the contacting portion are serially and integrally formed by bending process in a direction crossing a moving direction of the body toward the counterpart connector when the connector is coupled with the counterpart connector. At least a part of the contact which warps when the contacting portion contacts the contacting portion of the contact of the counterpart connector is processed for generating work hardening.

By such a configuration, at least the part of the contact, which serves as a plate spring, can be hardened without changing the thickness or the material of the contact. Thus, the elastic pressure acting between the contacts when the connector is coupled with the counterpart contact can be increased. As a result, the reliability of the connection can be maintained owing to the increase of the elastic pressure acting between the contacting portions of the contacts even when the stacking height is made lower.

Furthermore, a method for manufacturing a connector which is to be mounted on a first circuit board electrically for connecting the first circuit board to a second circuit board by coupling with a counterpart connector mounted on the second circuit board in accordance with an aspect of the present invention comprises: a step for forming a comb having a predetermined number of arrangement, a predetermined width and a predetermined pitch of teeth on a metal plate having a first thickness; a step for pressing the comb in a manner so that a thickness of at least a part of the comb, which will elastically contact contacting portions of contacts of the counterpart connector when the contact is coupled with the counterpart connector, is made to be a second thickness thinner than the first thickness; a step for bending the teeth of the comb serially and integrally for forming a terminal portion to be connected to the circuit board, a held portion to be fixed on the body, and a contacting portion to be elastically contacted with a contacting portion of a contact of the counterpart connector when the connector is coupled with the counterpart connector on each tooth; a step for fitting the held portions of the teeth into holding grooves formed on the body corresponding to the number of arrangement, the width and the pitch of the teeth of the comb so as to fix the metal plate on the body; and a step for cutting the terminal portions of the teeth of the comb from the metal plate.

### BRIEF DESCRIPTION OF THE DRAWINGS

FIG. 1 is an exploded view showing a configuration of a flip phone which is an example of a use of a connector in accordance with the present invention;

FIG. 2 is a cross sectional view showing a state that a header and a socket constituting connectors in an embodiment of the present invention are coupled;

FIG. 3A is a front view showing a configuration of the socket in the embodiment;

FIG. 3B is a side view of the socket;

FIG. 3C is a cross sectional view showing A-A section in FIG. 3A;

FIG. 4 is a plan view showing a blank for treating a plurality of contacts for the socket;

FIG. 5 is a front view showing a shape of the contact for the socket;

FIG. 6A is a front view showing a configuration of the header in the embodiment;

FIG. 6B is a side view of the header;

FIG. 6C is a cross sectional view showing B-B section in FIG. 6A;

FIG. 7 is a plan view showing a blank for treating a plurality of contacts for the header;

FIG. 8 is a front view showing a shape of the contact for the header;

FIG. 9 is a front view showing a modification of the contact for the socket in the embodiment;

FIG. 10 is a cross sectional view showing a modification of the connector in the embodiment;

FIG. 11 is a cross sectional view showing a configuration of a conventional socket;

FIG. 12 is a cross sectional view showing a configuration of a conventional header; and

FIG. 13 is a cross sectional view showing a state that the conventional header and the conventional socket are coupled.

### BEST MODE FOR CARRYING OUT THE INVENTION

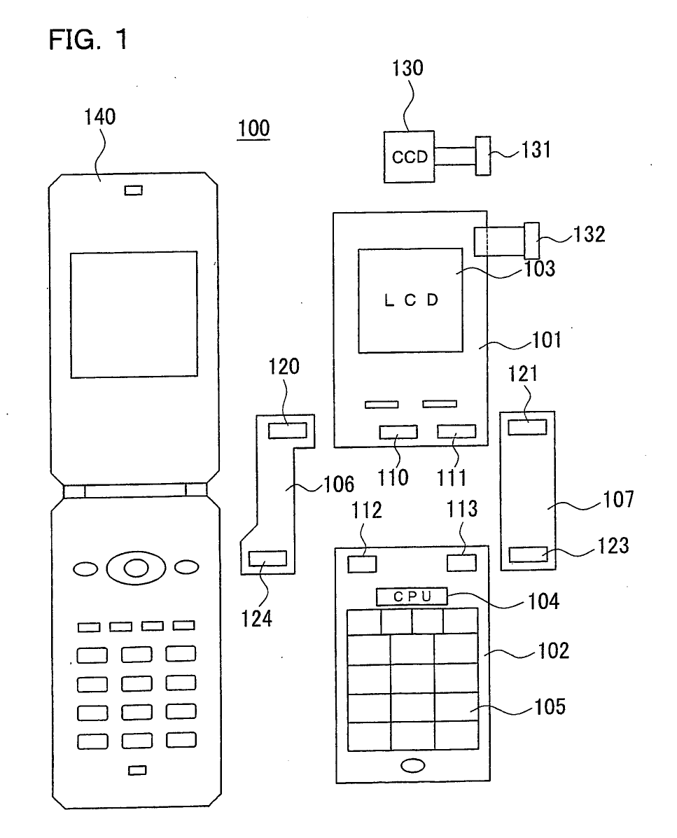

An embodiment of the present invention is described with reference to the drawings. FIG. 1 shows electric connections among circuit boards and electronic components in a flip phone, which is an example of the use of a connector in the embodiment of the present invention.

As can be seen from FIG. 1, the circuit boards of the flip phone 100 is separated into a first circuit board 101 on which an LCD 103 and so on are mounted and a second circuit board 102 on which a CPU 104, switch plate 105 and so on are mounted. Flexible substrates 106 and 107 connect between the first circuit board 101 and the second circuit board 102. Connectors 110, 111, 112 and 113 are respectively mounted on the first circuit board 101 and the second circuit board 102. Other connectors 120, 121, 122 and 123 are mounted on the flexible substrates 106 and 107 corresponding to the connectors 110 to 113. The first circuit board 101 is electrically connected to the second circuit board 102 via the connectors 110 to 113 and 120 to 123 and the flexible substrates 106 and 107. Similarly, the electronic component such as a CCD camera 130 is connected to the first circuit board 101 via connectors 131 and 132. In FIG. 1, numeral 140 designates a housing of the flip phone 100.

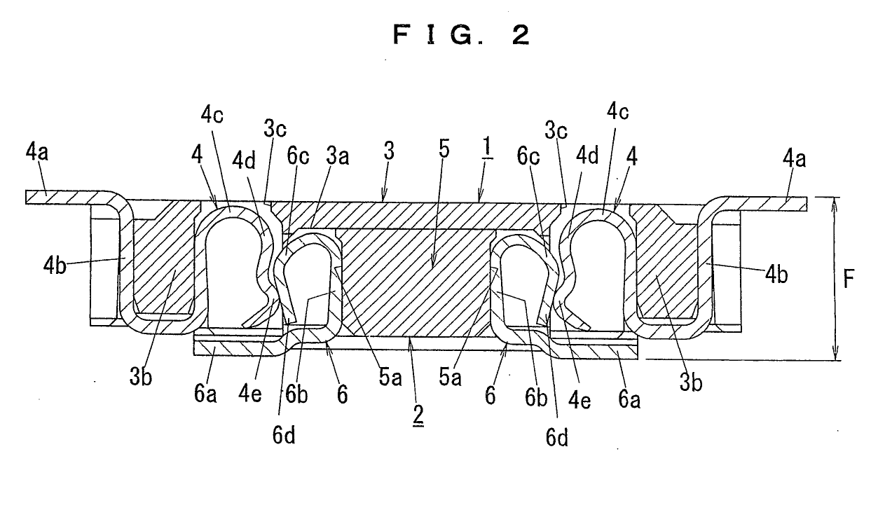

FIG. 2 shows a state that a socket 1 and a header 2, which are the connectors of this embodiment, are coupled. The connectors are required not only electrically to connect the contacts held on respective connectors but also to maintain the connection of the contacts. Thus, the connectors are generally constituted by a male connector and a female connector. In this embodiment, the socket 1 corresponding to the female connector and the header 2 corresponding to the male connector constitutes a pair of connectors which are respectively mounted on different circuit boards. In FIG. 2, the socket 1 is illustrated above the header 2. The relation of above and below between the socket 1 and the header 2 is not restricted by the illustration.

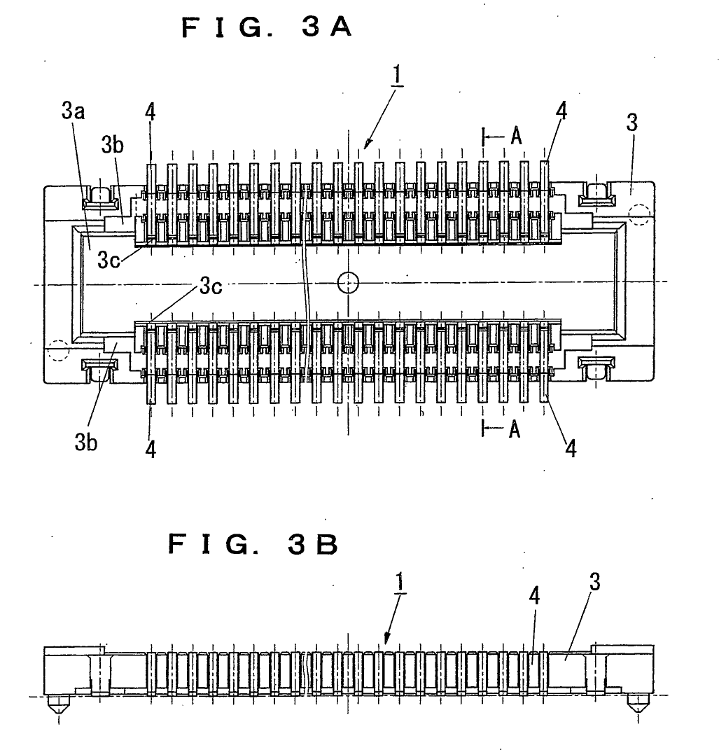

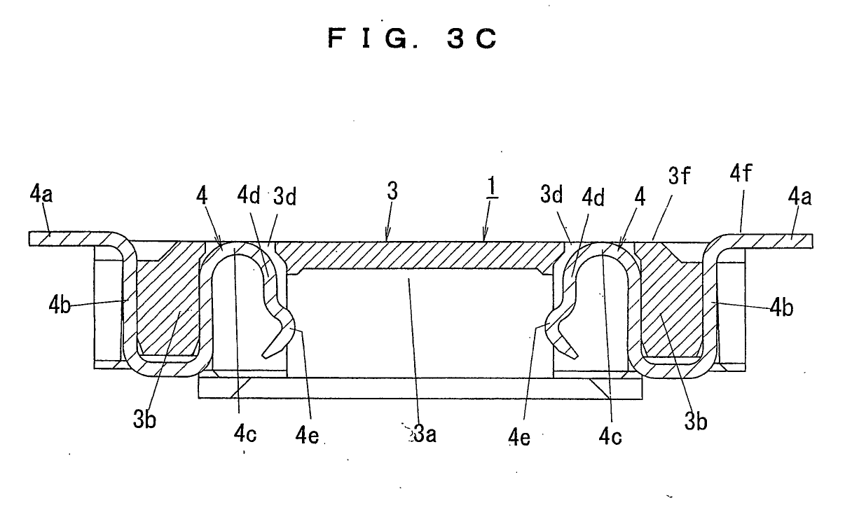

Detailed configuration of the socket 1 is shown in FIGS. 3A to 3C. FIG. 3A is a front view of the socket 1. FIG. 3B is a side view of the socket 1. FIG. 3C is an A-A sectional view of the socket 1. In FIG. 3C, the socket 1 is illustrated upside down corresponding to FIG. 2.

As can be seen from FIGS. 3A to 3C, the socket 1 comprises a body 3 having a rectangular parallelepiped shape and made of an insulation resin molding. A recess 3a having a substantially rectangular opening is formed on the body 3. A plurality of holding grooves 3c arranged in a lengthwise direction of the recess 3a is formed on both side walls 3b of the recess 3c. Contacts 4 are respectively press fitted into the holding grooves 3c. As can be seen from FIG. 3C, through-holes 3d are formed on a bottom of the recess 3a in the vicinities of both sides in widthwise direction of the recess 3a.

Each contact 4 is formed by bending an elastic metal plate such as a copper alloy plate surfaces of which are plated by gold so as to have a predetermined shape. A terminal portion 4a, at which the contact 4 is to be soldered on a circuit board, is formed on an end portion of the contact 4. A held portion 4b having a substantially horse shoe shaped section is formed at a center portion in a lengthwise direction of the contact 4 in a manner so that the horse shoe shaped section becomes substantially at right angle with respect to the terminal portion 4a. A bent portion 4c is formed by roundly bending an elongation of the held portion 4b in an opposite direction to the terminal portion 4a. A contacting portion 4d, which is to be contacted to a contact 6 of the header 2 described below, is formed on an elongation of the bent portion 4c. A protrusion 4e protruding in a direction depart from the held portion 4b is formed in the vicinity of the top end of the contacting portion 4d. In other words, the contact 4 of the socket 1 is bent in a manner so that the terminal portion 4a, the held portion 4b, the bent portion 4c and the contacting portion 4d of the contact 4 of the socket 1 are serially and integrally formed in a direction crossing a moving direction of the body 3 relative to the body 5 of the header 2 when the socket 1 is coupled with the header 2 serving as a counter part connector.

By forming the held portion 4b as the horse shoe shape so as to stride over the side wall 3b of the body 3, the terminal portion 4a can be disposed outside of the body 3 and the contacting portion 4d can be disposed inside the recess 3a. As shown in FIG. 3C, a face 4f of the terminal portion 4a which is to be soldered on the circuit board is disposed outwardly from an outer face 3f of the body 3. The bent portion 4c is disposed inside in the through-hole 3d from the outer face 3f of the body 3. Thus, the bent portion 4c rarely contacts a wiring pattern or the like on the circuit board even when the socket 1 is mounted on the circuit board, so that the short-circuit can be prevented. Furthermore, the side wall 3b of the body 3 standing between the terminal portion 4a and the contacting portion 4d can prevent the adhesion of flux or solder on the contacting portion 4d when the terminal portion 4a is soldered on the circuit board.

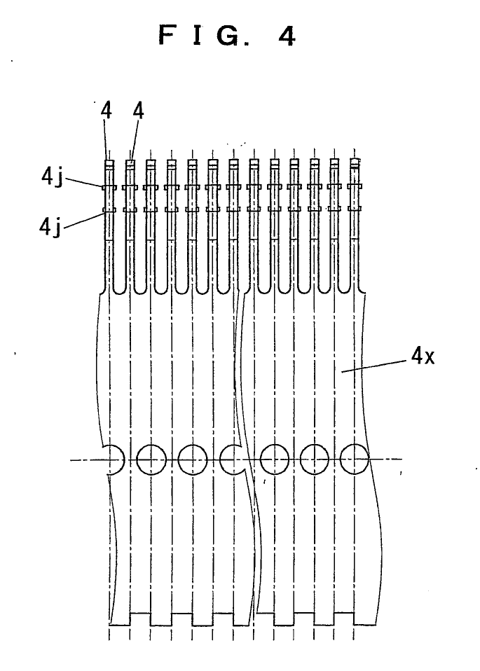

A width of the holding groove 3c of the body 3 is substantially the same as the width of the held portion 4b of the contact 4, but a width of a fitting part 4j of the held portion 4b (see FIG. 4) is a little wider than that of the holding groove 3c. When the held portion 4b of the contact 4 is press fitted into the holding groove 3c, both sides of the held portion 4b of the contact 4 tightly contact the inner walls of the holding groove 3c, so that the contact 4 is fixed on the body 3.

For example, the width of the contact 4 is 0.2 mm, the thickness of the stuff of metal plate for the contact 4 is 0.1 mm, and the pitch of the arrangement of the contacts 4 is about 0.4 to 0.5 mm. The number of the arrangement of the contacts 4 is about 10 to 30. It is very difficult to bend and to press fit such the minute contacts 4 one by one. As shown in FIG. 4, a stuff of metal plate 4x is processed to form a comb having the same number, width and pitch of teeth as the arrangement of the contacts 4 in the socket 1. The comb is pressed or hammered out in a manner so that the thickness of at least a part of the comb, which will elastically contact the contacting portions 6d of the contacts 6 of the header 2 serving as a counterpart connector when the socket 1 is coupled with the header 2, is made to be thinner than the thickness of the original stuff of metal plate. Subsequently, the teeth of the comb are bent to form all the contacts 4 on one side of the socket 1. The held portions 4b of the contacts 4 on the same side of the socket 1 are press fitted into the holding grooves 3c of the body 3 at the same time. After fixing the contacts 4 on the body 3 of the socket 1, the terminal portions 4a of the contacts 4 are cut from the stuff of metal plate 4x.

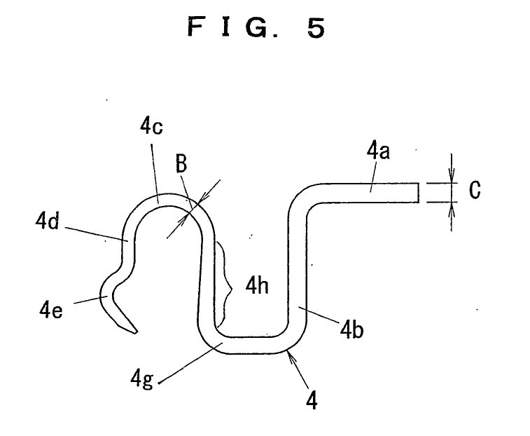

Thickness of the contact 4 of the socket 1 is described with reference to FIG. 5. As can be seen from FIG. 5, the contact 4 is pressed or hammered out in a manner so that a thickness of a part from points 4g of the held portion 4b disposed inside of the recess 3a of the body 3 to the top end of the contacting portion 4d are made thinner than the thickness of other portions. For example, the thickness “C” of the terminal portion 4a is 0.1 mm, and the thickness “B” of the portions from the bent portion 4c to the contacting portion 4d is about 0.08 mm. For preventing stress concentration due to sudden mutation of the thickness, a portion 4h from the point 4g of the held portion 4b to the bent portion 4c is tapered in a manner so that the thickness is gradually made thinner.

Since at least a part of the contact 4 including the contacting portion 4d is pressed or hammered out to be thinner than other portions, the contacting pressure generated by warping of the contacting portion 4d can be increased owing to the work hardening. Furthermore, it is possible to acuminate the top end of the contacting portion 4d. Alternatively, it is possible to process the portions from the point 4g of the held portion 4b to the top end of the contacting portion 4d in a manner so that the thickness is made thinner gradually or in stages.

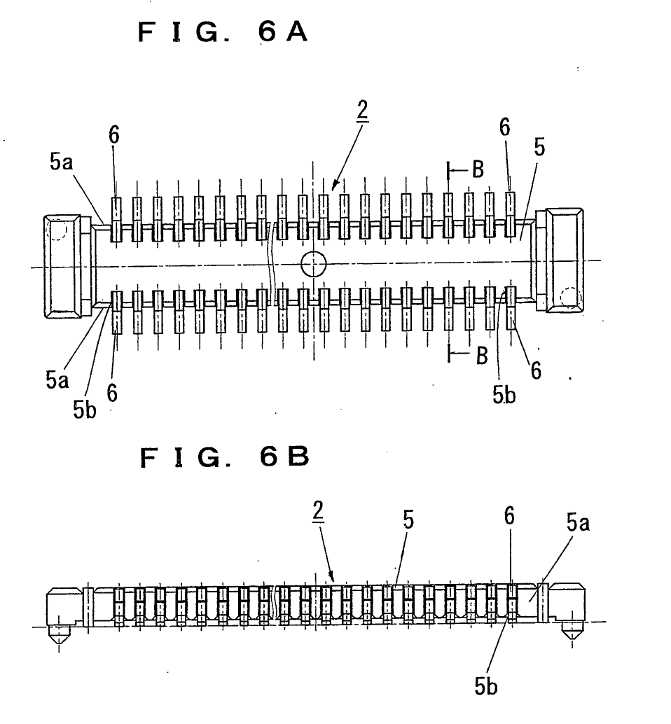

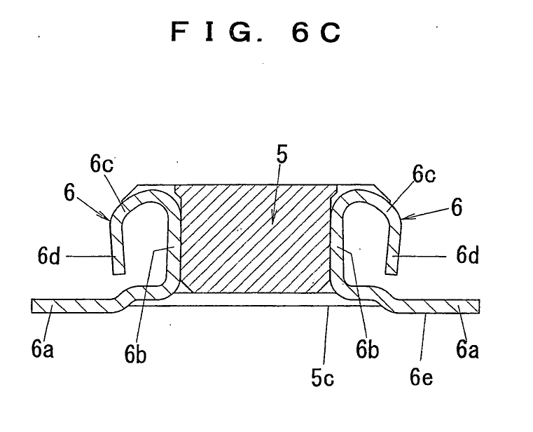

Subsequently, detailed configuration of the header 2 is shown in FIGS. 6A to 6C. FIG. 6A is a front view of the header 2. FIG. 6B is a side view of the header 2. FIG. 6C is a B-B sectional view of the header 2.

As can be seen from FIGS. 6A to 6C, the header 2 comprises a body 5 having a rectangular parallelepiped shape and made of an insulation resin molding. A plurality of holding grooves 5b arranged in a lengthwise direction of the body 5 is formed on both sides 5a of the body 5. Contacts 6 are respectively press fitted into the holding grooves 5b. Whole of the header 2 except terminal portions 6a of the contacts 6 are to be fitted into the recess 3a of the body 3 of the socket 1.

Similarly to the contact 4 of the socket 1, each contact 6 of the header 2 is formed by bending an elastic metal plate such as a copper alloy plate surfaces of which are plated by gold so as to have a predetermined shape. As shown in FIG. 6C, the terminal portion 6a, at which the contact 6 is to be soldered on a circuit board, is formed on an end portion of the contact 6. A held portion 6b which is to be press fitted into the holding groove 5b of the body 5 is formed on an elongation of the terminal portion 6a by bending substantially at right angle with respect to the terminal portion 6a. A bent portion 6c is formed by roundly bending an elongation of the held portion 6b in an opposite direction to the terminal portion 6a. A contacting portion 6d, which is to be contacted to the contact 4 of the socket 1, is formed on an elongation of the bent portion 6c. A face 6e of the terminal portion 6a which is to be soldered on the circuit board is disposed outwardly from an outer face 5c of the body 5.

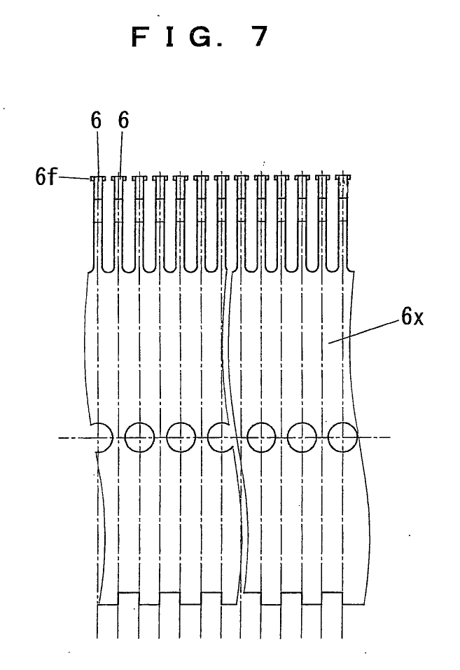

A width of the holding groove 5b of the body 5 is substantially the same as the width of the held portion 6b of the contact 6, but a width of a fitting part 6f of the held portion 6b (see FIG. 7) is a little wider than that of the holding groove 5b. When the held portion 6b of the contact 6 is press fitted into the holding groove 5b, both sides of the held portion 6b of the contact 6 tightly contact the inner walls of the holding groove 5b, so that the contact 6 is fixed on the body 5.

The width, number and pitch of arrangement of the contacts 6 of the header 2 are the same as those of the contacts 4 of the socket 1. The thickness and the material of the contacts 6 of the header 2 are not necessarily the same as those of the contacts 4 of the socket 1. It is possible to change the thickness and/or the material of the contacts 6 of the header 2 from those/that of the contacts 4 of the socket 1 corresponding to the shape and/or necessary elastic pressure of the contacts 6.

As shown in FIG. 7, similarly to the contact 4 of the socket 1, a stuff of metal plate 6x is processed to form a comb having the same number, width and pitch of teeth as the arrangement of the contacts 6 of the header 2. The comb is pressed or hammered out in a manner so that the thickness of at least a part of the comb, which will elastically contact the contacting portions 4d of the contacts 4 of the socket 1 serving as a counterpart connector when the header 2 is coupled with the socket 1, is made to be thinner than the thickness of the original stuff of metal plate. Subsequently, the teeth of the comb are bent to form all the contacts 6 on one side of the header 2. The held portions 6b of the contacts 6 on the same side of the header 2 are press fitted into the holding grooves 5b of the body 5 at the same time. After fixing the contacts 6 on the body 5 of the header 2, the terminal portions 6a of the contacts 6 are cut from the stuff of metal plate 6x.

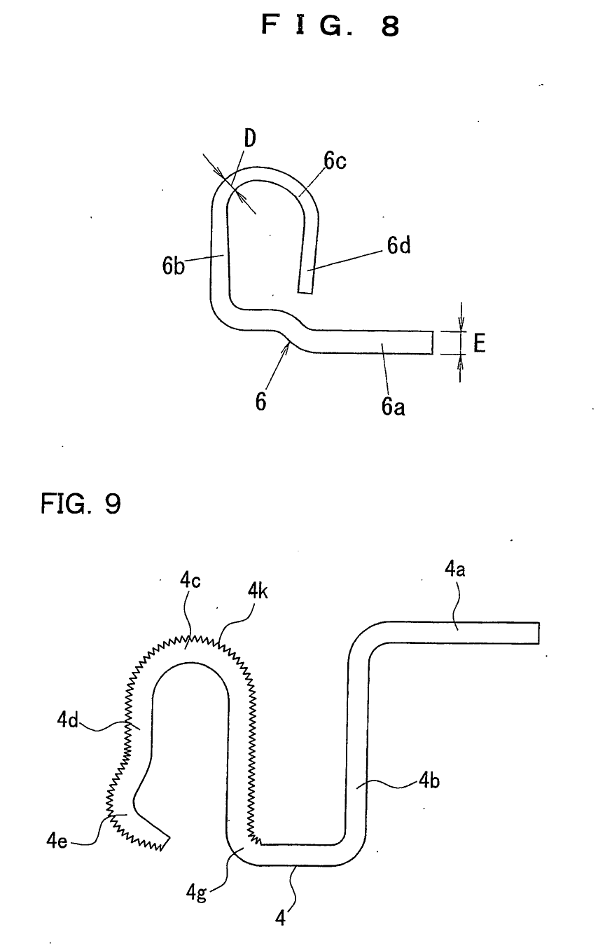

Thickness of the contact 6 of the header 2 is described with reference to FIG. 8. As can be seen from FIG. 8, the contact 6 is pressed or hammered out in a manner so that a thickness of a part from the held portion 6b to the top end of the contacting portion 6d are made thinner than the thickness of other portions. For example, the thickness “E” of the terminal portion 6a is 0.1 mm, and the thickness “D” of the portions from the bent portion 6c to the contacting portion 6d is about 0.08 mm. For preventing stress concentration due to sudden mutation of the thickness, the held portion 6b is tapered in a manner so that the thickness is gradually made thinner.

Since at least a part of the contact 6 including the contacting portion 6d is pressed or hammered out to be thinner than other portions, the contacting pressure generated by warping of the contacting portion 6d can be increased owing to the work hardening. Alternatively, it is possible to process the portions from the held portion 6b to the top end of the contacting portion 6d in a manner so that the thickness is made thinner gradually or in stages.

When the socket 1 and the header 2 are coupled as shown in FIG. 2, two pairs of protrusions 4e of the contacting portions 4d of the contacts 4 of the socket 1 and the contacting portions 6d of the contacts 6 of the header 2 elastically contact in longitudinal direction in each section including the contacts 4 and 6. As a result, gripping force is generated between the socket 1 and the header 2.

Since the part of the contact 4 of the socket 1 including the contacting portion 4d is pressed to be thinner than the other portions, the elastic pressure generated by warping the contacting portion 4d of the contact 4 is increased owing to the work hardening in comparison with the elastic pressure when the contacting portion 4d of the contact 4 is not pressed. Thus, the contacting pressure of the contacting portion 4d of the contact 4 of the socket 1 with respect to the contacting portion 6d of the contact 6 of the header 2 increases. Similarly, since the part of the contact 6 of the header 2 including the contacting portion 6d is pressed to be thinner than the other portions, the elastic pressure generated by warping of the contacting portion 6d of the contact 6 is increased owing to the work hardening. Thus, the contacting pressure of the contacting portion 6d of the contact 6 of the header 2 with respect to the contacting portion 4d of the contact 4 of the socket 1 increases. As a result, the gripping force acting between the socket 1 and the header 2 is increased owing to the increase of the contacting pressures acting between the contacts 4 and 6, so that the reliability of the connection of the socket 1 and the header 2 can be maintained even though the stacking height is made lower. Specifically, the lowest stacking height “A” in the conventional connectors shown in FIG. 13 was about 1.5 mm. On the other hand, the stacking height “F” of the connectors according to this embodiment shown in FIG. 2 can be made 1.2 mm with maintaining substantially the same impact proof as that of the conventional connectors. In the mobile equipment such as the flip phone, the fact that the stacking height can be reduced about 0.3 mm, that is, about 20% is very effective to make the profile of the equipment lower.

When the specification of the contacts except the low stacking height is substantially the same as that of the conventional contacts, the stuff of metal plate having substantially the same thickness as that of the contacts 14 and 16 of the conventional connectors can be used as the stuff of the contacts 4 and 6 in this embodiment. Thus, the mechanical strength of the contacts 4 and 6 can be maintained, so that the contacts 4 and 6 are rarely deformed while they are treated as components or while they are assembled.

Furthermore, since a thickness of a part of the contact 4 from the terminal portion 4a to the point 4g of the held portion 4b is maintained as the original thickness of the stuff of metal plate without hammering out, a contacting area of the fitting part 4j of the held portion 4b with respect to the inner walls of the holding groove 3c of the body 3 becomes wider in comparison with the case that the thickness of whole of the contact 4 is evenly made thinner by hammering out. Thus, the gripping force acting between the held portion 4b and the holding groove 3c when the contact 4 is press fitted into the holding groove 3c of the body 3 can be increased. The same goes for the contact 6 of the header 2.

In the present invention, at least a part of the contact 4 or 6 which warps when the contacting portion 4d or 6d contacts the contacting portion 6d or 4d of the contact 6 or 4 of the counterpart connector is processed for generating the work hardening. Method for generating the work hardening is not restricted by the above-mentioned description. For example, it is possible to press or hammer out a portion of the contact 4 or 6 generating the elastic force evenly in a manner so that the thickness of the pressed portion becomes thinner than other portions. Conceivably, it is possible to press or hammer out the portion of the contact 4 or 6 generating the elastic force to be tapered so that the thickness of the pressed portion becomes gradually thinner. Conceivably, it is possible to press or hammer out the portion of the contact 4 or 6 generating the elastic force in a manner so that the thickness of the pressed portion becomes thinner in steps.

Furthermore, for increasing the elastic pressure owing to the work hardening, the thickness of the contact 4 or 6 is not necessarily made thinner. As shown in FIG. 9, it is possible to form minute convex and concave patterns 4k on a surface of the contact 4. For example, corrugation can be adopted as the convex and concave patterns 4k. The same goes for the contact 6.

Furthermore, it is possible to press or hammer out whole of the contact 4 or 6 in a manner so that the thickness at every portions of the contact 4 or 6 is made thinner than the original thickness of the stuff metal plate.

By selecting the method for obtaining the work hardening, the spring characteristics of the contacting portions 4d and 6d of the contacts 4 and 6 can freely be taken.

In the above-mentioned description, both of the contact 4 of the socket 1 and the contact 6 of the header 2 are processed so as to generate the work hardening in the portions including the contacting portions 4c and 6c. When only one of the contact 4 of the socket 1 and the contact 6 of the header 2 is processed for generating the work hardening, substantially the same effect can be obtained.

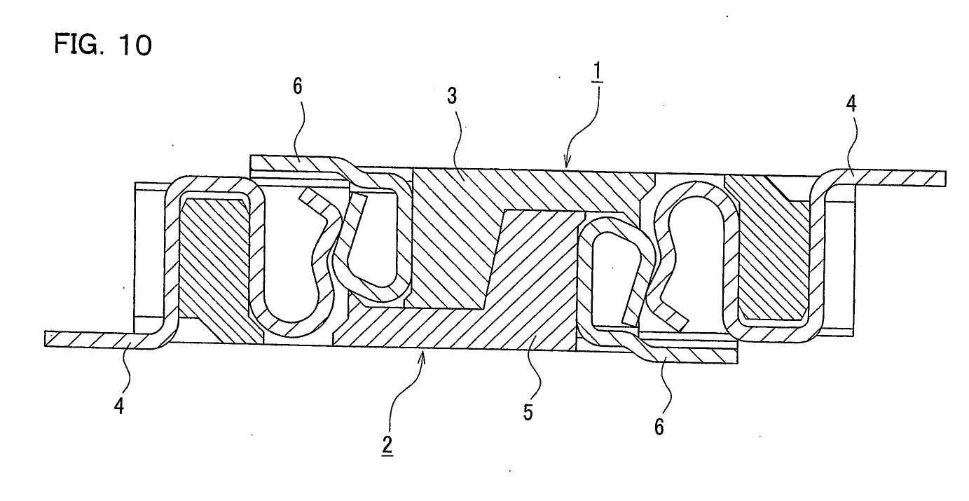

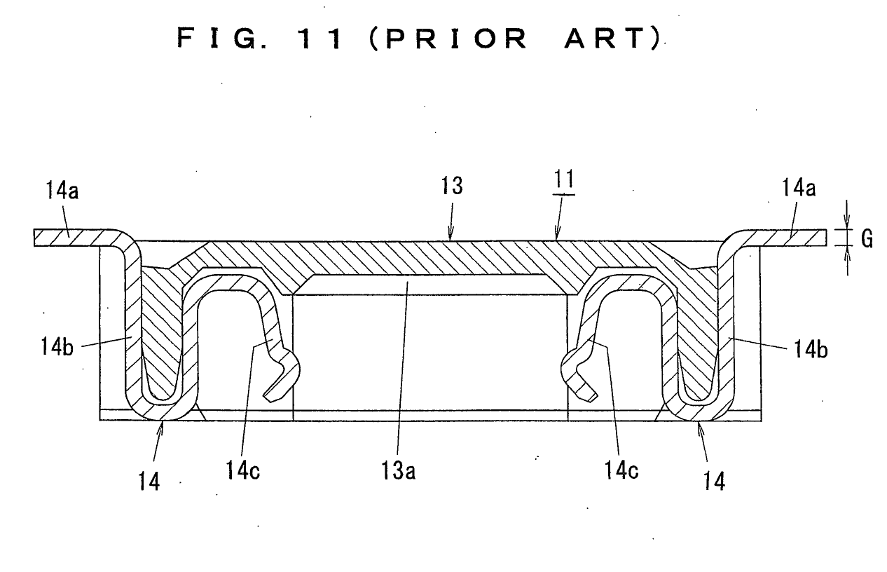

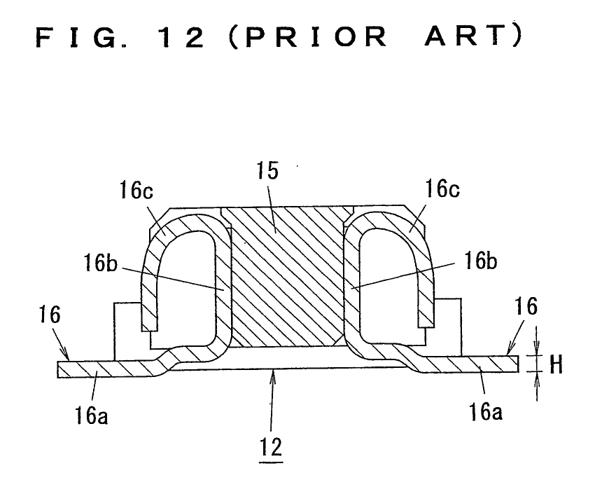

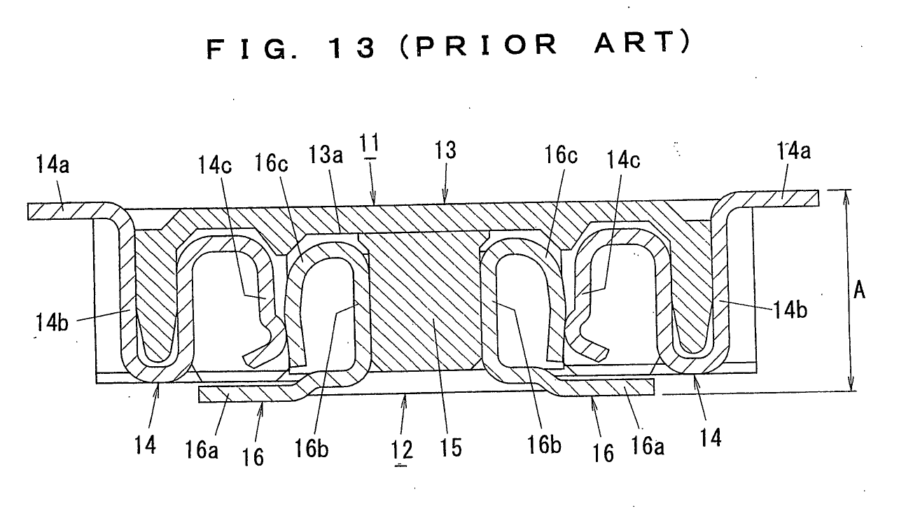

Furthermore, in the above-mentioned description, a plurality of pairs of the same shaped contacts 4 and 6 is arranged symmetrically with respect to an axis parallel to the arranging direction in the socket 1 and the header 2. The present invention, however, is not restricted by such the symmetrical configuration. It is possible to arrange a plurality of sets of different shaped two contacts with respect to a predetermined axis parallel to the arranging direction so as to take a predetermined positioning relation. As shown in FIG. 10, one of the arrangements of the contacts in the arrangement of the socket 1 and the header 2 is constituted by the contacts having the same shape as the contact 4 and the other of arrangements of the contacts is constituted by the contacts having the same shape as the contact 6. The body 3 of the socket 1 and the body 5 of the header 2 are deformed corresponding to the shape of the contacts. By such a configuration, the same shaped connectors can be mounted on the circuit boards electrically for connecting the circuit boards without distinguishing the socket 1 and the header 2.

This application is based on Japanese patent application 2002-18856 filed in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

Industrial Applicability

In the connector in accordance with the present invention, the portion of the contact including at least the contacting portion which warps when the connector is coupled with a counterpart connector is processed for generating the work hardening, so that the elastic pressure of the contacting portion of the contact is increased owing to the work hardening in comparison with the contact which is not processed for generating the work hardening. Thus, the contacting pressure acting between the contacting portion of the contact and another contacting portion of another contact of the counterpart contact is increased. Even when the stacking height of the contacts is made lower, the reliability of the connection of the contacts can be maintained.

1. A connector mounted on a first circuit board electrically for connecting the first circuit board to a second circuit board by coupling with a counterpart connector mounted on the second circuit board and comprising contacts made of a metal and a body made of an insulation material for holding the contacts, wherein
each contact has a terminal portion to be connected to the circuit board, a held portion to be fixed on the body, and a contacting portion to be elastically contacted with a contacting portion of a contact of the counterpart connector when the connector is coupled with the counterpart connector;
the terminal portion, the held portion and the contacting portion are serially and integrally formed by bending process in a direction crossing a moving direction of the body toward the counterpart connector when the connector is coupled with the counterpart connector; and
at least a part of the contact which warps when the contacting portion contacts the contacting portion of the contact of the counterpart connector is processed for generating work hardening.

2. The connector in accordance with claim 1, wherein a thickness of at least the part of the contact which warps when the contacting portion contacts the contacting portion of the contact of the counterpart connector is made thinner than a thickness of other portions.

3. The connector in accordance with claim 2, wherein the thickness of at least the part of the contact which warps when the contacting portion contacts the contacting portion of the contact of the counterpart connector is made evenly thinner than the thickness of other portions.

4. The connector in accordance with claim 2, wherein the thickness of at least the part of the contact which warps when the contacting portion contacts the contacting portion of the contact of the counterpart connector is tapered to be gradually thinner than the thickness of other portions.

5. The connector in accordance with claim 2, wherein the thickness of at least the part of the contact which warps when the contacting portion contacts the contacting portion of the contact of the counterpart connector is made thinner in steps than the thickness of other portions.

6. The connector in accordance with claim 1, wherein a surface of at least the part of the contact which warps when the contacting portion contacts the contacting portion of the contact of the counterpart connector is processed to be formed minute convex and concave patterns thereon.

7. The connector in accordance with claim 6, wherein the minute convex and concave patterns are corrugation.

8. The connector in accordance with claim 1, wherein a thickness of whole the contact is made thinner than a thickness of a stuff metal plate of the contact.

9. The connector in accordance with claim 1, wherein a plurality of sets of contacts is arranged in a predetermined direction on the body.

10. The connector in accordance with claim 9, wherein each set of contacts is constituted by two contacts having substantially the same shape and disposed symmetrically with respect to an axis parallel to an arranging direction.

11. The connector in accordance with claim 10, wherein the contacting portion of the contact is formed in opposite direction to the terminal portion with respect to the held portion.

12. The connector in accordance with claim 10, wherein the contacting portion of the contact is formed in the same direction to the terminal portion with respect to the held portion.

13. The connector in accordance with claim 9, wherein each set of contacts is constituted by two contacts respectively having different shape and disposed for taking a predetermined positioning relation with respect to an axis parallel to an arranging direction.

14. The connector in accordance with claim 13, wherein the connector mounted on the first circuit board and the counterpart connector mounted on the second circuit board have the same shape.

15. A method for manufacturing a connector, which is to be mounted on a first circuit board electrically for connecting the first circuit board to a second circuit board by coupling with a counterpart connector mounted on the second circuit board, comprising:
a step for forming a comb having a predetermined number of arrangement, a predetermined width and a predetermined pitch of teeth on a metal plate having a first thickness;
a step for pressing the comb in a manner so that a thickness of at least a part of the comb, which will elastically contact contacting portions of contacts of the counterpart connector when the contact is coupled with the counterpart connector, is made to be a second thickness thinner than the first thickness;
a step for bending the teeth of the comb serially and integrally for forming a terminal portion to be connected to the circuit board, a held portion to be fixed on the body, and a contacting portion to be elastically contacted with a contacting portion of a contact of the counterpart connector when the connector is coupled with the counterpart connector on each tooth;
a step for fitting the held portions of the teeth into holding grooves formed on the body corresponding to the number of arrangement, the width and the pitch of the teeth of the comb so as to fix the metal plate on the body; and
a step for cutting the terminal portions of the teeth of the comb from the metal plate.
